(19) United States
(12) Patent Application Publication
(10) Pub. No.: US 2026/0320312 A1
(43) Pub. Date: Oct. 15, 2026

(54) AUGMENTING TRAINING OF SEQUENCE TRANSDUCTION MODELS USING TOKEN-LEVEL LOSSES

(71) Applicant: Google LLC, Mountain View, CA (US)

(72) Inventors: Guanlong Zhao, Long Island City, NY (US); Quan Wang, Hoboken, NJ (US); Beltrán Labrador Serrano, Madrid (ES); Han Lu, Redmond, WA (US); Ignacio Lopez Moreno, Brooklyn, NY (US); Yiling Huang, Edgewater, NJ (US)

(73) Assignee: Google LLC, Mountain View, CA (US)

(21) Appl. No.: 19/117,206

(22) PCT Filed: Nov. 11, 2022
(86) PCT No.: PCT/US2022/079703

§ 371 Date: Mar. 31, 2025

Related U.S. Application Data
(60) Provisional application No. 63/379,135, filed on Oct. 11, 2022.

(51) Int. Cl. G06F 40/58; G06N 3/044; G10L 15/06

(52) U.S. Cl. CPC G06F 40/58; G06N 3/044; G10L 15/063

(57) ABSTRACT

A method (500) includes, for each training sample (410) of a plurality of training samples: processing, using a sequence transduction model (200), corresponding training input features (415) to obtain one or more output token sequence hypotheses (432) each including one or more predicted common tokens (204); and determining a token-level loss (462) based on, for each hypothesis: a number of special token insertions each associated with a corresponding predicted special token that appears in the hypothesis but does not appear in a corresponding sequence of ground-truth output tokens; and a number of special token deletions each associated with a corresponding ground-truth special token in the set of ground-truth special tokens that does not appear in hypothesis. The method also includes training the sequence transduction model to minimize additive error rate based on the token-level losses determined for the plurality of training samples.

### TECHNICAL FIELD

This disclosure relates to the training of sequence transduction models.

### BACKGROUND

Sequence transduction models are constructed and trained for transforming input sequences into output sequences. Example sequence transduction models include, but are not limited to, speech recognition models for transforming a sequence of input audio features into a transcription including a sequence of words or sub-word units, character recognition models for transforming a sequence of hand-written characters into a sequence of word or sub-word text pieces, and machine translation models for transforming a first sequence of words in a first language into a second sequence of words in a second language.

### SUMMARY

One aspect of the disclosure provides a computer-implemented method that, when executed on data processing hardware, causes the data processing hardware to perform operations for augmenting training of sequence transduction models using token-level losses. The operations include receiving a plurality of training samples each including a corresponding sequence of training input features paired with a corresponding sequence of ground-truth output tokens, the sequence of ground-truth output tokens including a set of ground-truth common tokens and a set of ground-truth special tokens. For each training sample in the plurality of training samples, the operations include processing, using a sequence transduction model, the corresponding sequence of training input features to obtain one or more output token sequence hypotheses, each output token sequence hypothesis including one or more predicted common tokens; and determining a per sample token-level loss based on, for each corresponding output token sequence hypothesis obtained for the training sample: a number of special token insertions each associated with a corresponding predicted special token that appears in the corresponding output token sequence hypothesis but does not appear in the corresponding sequence of ground-truth output tokens; and a number of special token deletions each associated with a corresponding ground-truth special token in the set of ground-truth special tokens that does not appear in corresponding output token sequence hypothesis. The operations further include training the sequence transduction model to minimize additive error rate based on the per sample token-level losses determined for the plurality of training samples.

Implementations of the disclosure may include one or more of the following optional features. In some implementations, the operations further include determining the per sample token-level loss is further based on a total number of ground-truth output tokens in the corresponding sequence of ground-truth output tokens and a respective number of predicted common token errors relative to the set of ground-truth common tokens in the corresponding sequence of ground-truth tokens; and when determining the per sample token-level loss, the number of special token insertions and the number of special token deletions are each weighted higher than the respective number of predicted common token errors to force the sequence transduction model to reduce special token insertion and deletion rates during training. In some examples, the operations further include, for each training sample in the plurality of training samples: processing, using the sequence transduction model, the corresponding sequence of training input features to predict probability distributions over possible output tokens; and training the sequence transduction model based on a negative log of the probability distributions for the corresponding sequence of ground-truth output tokens conditioned on the corresponding sequence of training input features. Here, training the sequence transduction model based on the negative log of the probability distributions may include initially training the sequence transduction model based on the negative log of the probability distributions to initialize the sequence transduction model; and training the sequence transduction model to minimize additive error rate based on the per sample token-level losses may include fine tuning the initialized sequence transduction model based on minimizing the additive error rate based on the per sample token-level losses.

In some examples, processing the corresponding sequence of training input features to obtain one or more output token sequence hypotheses includes processing the corresponding sequence of training input features to obtain an N-best list of output token sequence hypotheses, each corresponding output token sequence hypothesis in the N-best list having a respective probability score assigned by the sequence transduction model; and determining the per sample token-level loss is further based on the respective probability score of the corresponding output token sequence hypotheses. In some implementations, the sequence of training input features includes a sequence of input audio frames characterizing an utterance that includes a particular key phrase; the set of ground-truth common tokens in each corresponding sequence of ground-truth output tokens includes a set of word or sub-word unit tokens that form a ground-truth transcription of the utterance characterized by the sequence of input audio frames; the set of ground-truth special tokens in each corresponding sequence of ground-truth output tokens includes at least one ground-truth keyword token indicating a respective location in the ground-truth transcription immediately after the particular key phrase appears in the ground-truth transcription; the one or more predicted common tokens of each corresponding output token sequence hypothesis of the one or more output token sequence hypotheses includes a sequence of predicted word or sub-word tokens that form a respective candidate transcription of the utterance; and each corresponding predicted special token that appears in the corresponding output token sequence hypothesis but does not appear in the corresponding sequence of ground-truth output tokens includes a predicted key phrase token indicating a respective location in the respective candidate transcription immediately after the sequence transduction model predicts that the particular key phrase is detected.

In some implementations, the sequence of training input features includes a sequence of input audio frames characterizing multiple utterances spoken by at least two different speakers; the set of ground-truth common tokens in each corresponding sequence of ground-truth output tokens includes a set of word or sub-word unit tokens that form a ground-truth transcription of the multiple spoken utterances characterized by the sequence of input audio frames; the set of ground-truth special tokens in each corresponding sequence of ground-truth output tokens includes a set of one or more ground-truth speaker change tokens each indicating a respective location where a speaker change occurs in the ground-truth transcription of the multiple utterances; the one or more predicted common tokens of each corresponding output token sequence hypothesis of the one or more output token sequence hypotheses includes a sequence of predicted word or sub-word unit tokens that form a respective candidate transcription of the multiple utterances; and each corresponding predicted special token that appears in the corresponding output token sequence hypothesis but does not appear in the corresponding sequence of ground-truth output tokens includes a predicted speaker change token indicating a respective location in the respective candidate transcription where a respective speaker change event is detected by the sequence transduction model.

In some examples, the operations further include, for each training sample in plurality of training samples: determining a customized Levenshtein distance between each corresponding output token sequence hypothesis of the one or more output token sequence hypotheses obtained for the corresponding sequence of training input features and the corresponding sequence of ground-truth output tokens; and based on the customized Levenshtein distance: identifying the number of special token insertions for each corresponding output token sequence hypothesis; and identifying the number of special token deletions for each corresponding output token sequence hypothesis. Here, the customized Levenshtein distance determined between each corresponding output token sequence hypothesis and the corresponding sequence of ground-truth output tokens may prevent the sequence transduction model from allowing substitutions between special tokens and common tokens during training of the sequence transduction model.

In some implementations, the sequence transduction model includes a recurrent neural network-transducer (RNN-T) model architecture. Additionally, the sequence transduction model may include at least one of a speech recognition model, a character recognition model, an endpointing model, a speaker turn detection model, or a machine translation model.

Another aspect of the disclosure provides a system that includes data processing hardware and memory hardware storing instructions that, when executed on the data processing hardware, cause the data processing hardware to perform operations. The operations include receiving a plurality of training samples each including a corresponding sequence of training input features paired with a corresponding sequence of ground-truth output tokens, the sequence of ground-truth output tokens including a set of ground-truth common tokens and a set of ground-truth special tokens. For each training sample in the plurality of training samples, the operations include processing, using a sequence transduction model, the corresponding sequence of training input features to obtain one or more output token sequence hypotheses, each output token sequence hypothesis including one or more predicted common tokens; and determining a per sample token-level loss based on, for each corresponding output token sequence hypothesis obtained for the training sample: a number of special token insertions each associated with a corresponding predicted special token that appears in the corresponding output token sequence hypothesis but does not appear in the corresponding sequence of ground-truth output tokens; and a number of special token deletions each associated with a corresponding ground-truth special token in the set of ground-truth special tokens that does not appear in corresponding output token sequence hypothesis. The operations further include training the sequence transduction model to minimize additive error rate based on the per sample token-level losses determined for the one or more output token sequence hypotheses obtained for each training sample in the plurality of training samples.

Implementations of the disclosure may include one or more of the following optional features. In some implementations, the operations further include determining the per sample token-level loss is further based on a total number of ground-truth output tokens in the corresponding sequence of ground-truth output tokens and a respective number of predicted common token errors relative to the set of ground-truth common tokens in the corresponding sequence of ground-truth tokens; and when determining the per sample token-level loss, the number of special token insertions and the number of special token deletions are each weighted higher than the respective number of predicted common token errors to force the sequence transduction model to reduce special token insertion and deletion rates during training. In some examples, the operations further include, for each training sample in the plurality of training samples: processing, using the sequence transduction model, the corresponding sequence of training input features to predict probability distributions over possible output tokens; and training the sequence transduction model based on a negative log of the probability distributions for the corresponding sequence of ground-truth output tokens conditioned on the corresponding sequence of training input features. Here, training the sequence transduction model based on the negative log of the probability distributions may include initially training the sequence transduction model based on the negative log of the probability distributions to initialize the sequence transduction model; and training the sequence transduction model to minimize additive error rate based on the per sample token-level losses may include fine tuning the initialized sequence transduction model based on minimizing the additive error rate based on the per sample token-level losses.

In some examples, processing the corresponding sequence of training input features to obtain one or more output token sequence hypotheses includes processing the corresponding sequence of training input features to obtain an N-best list of output token sequence hypotheses, each corresponding output token sequence hypothesis in the N-best list having a respective probability score assigned by the sequence transduction model; and determining the per sample token-level loss for each corresponding output token sequence hypothesis in in the N-best list is further based on the respective probability score of the corresponding output token sequence hypotheses. In some implementations, the sequence of training input features includes a sequence of input audio frames characterizing an utterance that includes a particular key phrase; the set of ground-truth common tokens in each corresponding sequence of ground-truth output tokens includes a set of word or sub-word unit tokens that form a ground-truth transcription of the utterance characterized by the sequence of input audio frames; the set of ground-truth special tokens in each corresponding sequence of ground-truth output tokens includes at least one ground-truth keyword token indicating a respective location in the ground-truth transcription immediately after the particular key phrase appears in the ground-truth transcription; the one or more predicted common tokens of each corresponding output token sequence hypothesis of the one or more output token sequence hypotheses includes a sequence of predicted word or sub-word tokens that form a respective candidate transcription of the utterance; and each corresponding predicted special token that appears in the corresponding output token sequence hypothesis but does not appear in the corresponding sequence of ground-truth output tokens includes a predicted key phrase token indicating a respective location in the respective candidate transcription immediately after the sequence transduction model predicts that the particular key phrase is detected.

In some implementations, the sequence of training input features includes a sequence of input audio frames characterizing multiple utterances spoken by at least two different speakers; the set of ground-truth common tokens in each corresponding sequence of ground-truth output tokens includes a set of word or sub-word unit tokens that form a ground-truth transcription of the multiple spoken utterances characterized by the sequence of input audio frames; the set of ground-truth special tokens in each corresponding sequence of ground-truth output tokens includes a set of one or more ground-truth speaker change tokens each indicating a respective location where a speaker change occurs in the ground-truth transcription of the multiple utterances; the one or more predicted common tokens of each corresponding output token sequence hypothesis of the one or more output token sequence hypotheses includes a sequence of predicted word or sub-word unit tokens that form a respective candidate transcription of the multiple utterances; and each corresponding predicted special token that appears in the corresponding output token sequence hypothesis but does not appear in the corresponding sequence of ground-truth output tokens includes a predicted speaker change token indicating a respective location in the respective candidate transcription where a respective speaker change event is detected by the sequence transduction model.

In some examples, the operations further include, for each training sample in plurality of training samples: determining a customized Levenshtein distance between each corresponding output token sequence hypothesis of the one or more output token sequence hypotheses obtained for the corresponding sequence of training input features and the corresponding sequence of ground-truth output tokens; and based on the customized Levenshtein distance: identifying the number of special token insertions for each corresponding output token sequence hypothesis; and identifying the number of special token deletions for each corresponding output token sequence hypothesis. Here, the customized Levenshtein distance determined between each corresponding output token sequence hypothesis and the corresponding sequence of ground-truth output tokens may prevent the sequence transduction model from allowing substitutions between special tokens and common tokens during training of the sequence transduction model.

In some implementations, the sequence transduction model includes a recurrent neural network-transducer (RNN-T) model architecture. Additionally, the sequence transduction model may include at least one of a speech recognition model, a character recognition model, an endpointing model, a speaker turn detection model, or a machine translation model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view an example system including a sequence transduction model for performing speech recognition.

FIG. 2 is a schematic view of an example recurrent neural network-transducer (RNN-T) model of the sequence transduction model of FIG. 1.

FIG. 3 is a schematic view of an example tied and reduced prediction network of the RNN-T model of FIG. 3.

FIG. 4 is a schematic view of an example two-stage process for augmenting training of a sequence transduction model with token-level losses.

FIG. 5 is a flowchart of an example arrangement of operations for a computer-implemented method for augmenting training of a sequence transduction model with token-level losses.

FIG. 6 is a schematic view of an example computing device that may be used to implement the systems and methods described herein.

Like reference symbols in the various drawings indicate like elements.

### DETAILED DESCRIPTION

In addition to transforming between input sequences and output sequences, sequence transduction models have also been constructed for detecting special input conditions and generating special outputs (e.g., special output tokens or other types of indications) when special input conditions are detected. That is, sequence transduction models may be constructed and trained to process a sequence of input data to generate a predicted sequence of outputs that includes, in addition to other normal/common predicted outputs, special outputs (e.g., special output tokens or other types of indications) when the sequence transduction model detects corresponding special input conditions in the input data. Here, predicted common outputs are associated with inputs that are not associated with a special input condition. For example, an automatic speech recognition (ASR) model may be constructed and trained to detect special input conditions in a sequence of input audio features (i.e., captured input audio data) and to include or embed special output tokens in output transcriptions (i.e., an output sequence or word or sub-word units) that represent the detected special input conditions. Here, special input conditions include, but are not limited to, a speaker change (i.e., a change in who is speaking), a spoken key phrase (e.g., a spoken hotword, such as “Hey Assistant”, or a spoken warm word, such as “Volume Up”). In an example, the ASR model generates a predicted transcription “Hey Assistant <hw>, what time is it” from captured input audio data representing a spoken utterance of “Hey Assistant, what time is it.” Here, the transcription includes the special output token “<hw>” immediately following “Hey Assistant” to indicate that the ASR model identified “Hey Assistant” as a spoken hotword, and common tokens representing the other spoken words. Other example sequence transduction models include, but are not limited to, a character recognition model, and a machine translation model. Here, example special input conditions include, but are not limited to, a potentially offensive word, a special character, an equation, and a proper noun.

However, traditional methods of training sequence transduction models for detecting special input conditions have been problematic, at least because special input conditions in training data are sparse relative to common inputs. For example, the occurrence rate of speaker changes, key phrases, etc. in spoken utterance training samples may be orders of magnitudes less than non-special spoken words. Moreover, in some examples, there are significantly fewer possible unique special tokens (e.g., just “<st>” and “<hw”) than there are possible common tokens (e.g., all words in the English language). Traditionally, sequence transduction models have been trained using negative log likelihood losses computed for entire output sequences (i.e., including common outputs and infrequent special outputs), and the sparsity of special input conditions in training data causes the special outputs to be de-emphasized during training, which degrades detection accuracy for special input conditions.

Implementations herein are directed toward augmenting the training of sequence transduction models for detecting special input conditions using token-level losses. In particular implementations disclosed herein, a training process initially trains a sequence transduction model in a first training pass using training data that includes a set/plurality of training samples that each include a sequence of input data paired with a corresponding sequence of ground-truth outputs. Here, the ground-truth outputs include, in addition to common outputs, special ground-truth outputs for corresponding special input conditions in the input data. An example training sample includes captured input audio data representing a spoken utterance of “Hey Assistant, what is today's weather” and a corresponding ground-truth transcription of “Hey Assistant <hw>, what is today's weather.” Here, the ground-truth transcription includes the special output token “<hw>” immediately following “Hey Assistant” to indicate that the speech recognition model identified “Hey Assistant” as a spoken hotword/key phrase, and common tokens representing the other spoken words or sub-word units of the utterance. The initial training in the first training pass may be performed using a conventional loss function (e.g., minimizing a negative log likelihood) based on differences between predicted outputs of the sequence transduction model and corresponding ground-truth outputs, both of which include special outputs for special input conditions. Notably, during the first training pass, the losses are computed for entire predicted output sequences (i.e., including common outputs and infrequent special outputs) for each particular training sample.

The training process then re-trains or fine tunes the training of sequence transduction model in a second training pass using the same training data, for example. For each training sample during the second training pass, the training process performs a beam search to identify the N-best predicted output sequences (i.e., output token sequence hypotheses) based on the input data for the training sample. The training process performs the re-training in the second training pass using loss function that is a weighted sum of a token-level loss function and a conventional loss function. The conventional loss function may be the same as that used during the initial training in the first training pass. In some implementations, the token-level loss function includes a minimum additive error rate, such as a minimum word error rate (MWER) or a word-level edit-based minimum Bayes risk (EMBR), and losses associated with special tokens are given greater loss values than the losses associated with regular tokens.

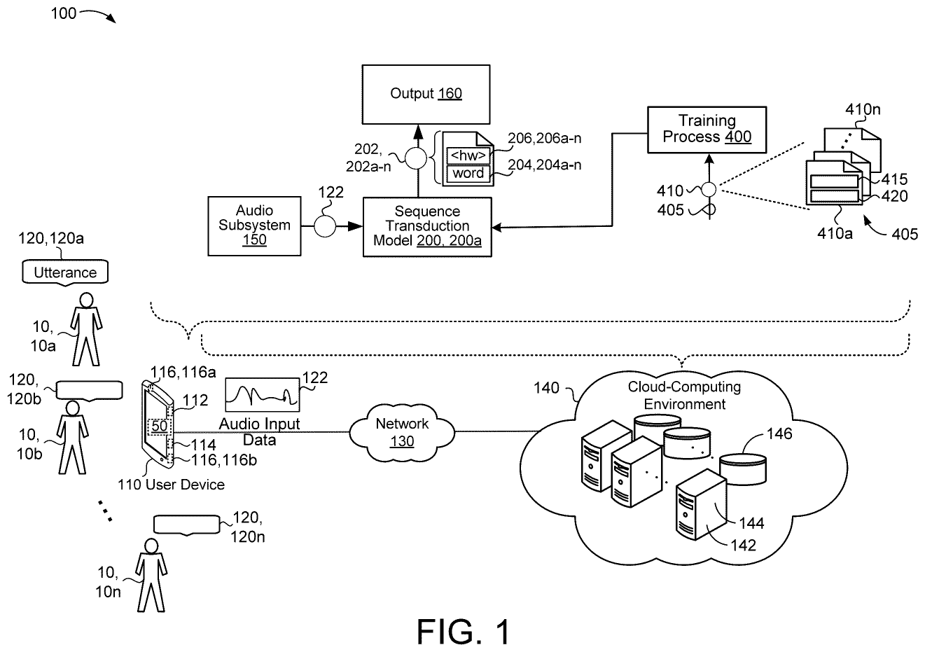

Referring to FIG. 1, an example system 100 includes a user device 110 for capturing input audio data 122 (i.e., a sequence of input audio features 122) representing one or more utterances 120, 120a-n spoken by one or more speakers (e.g., users or persons) 10, 10a-n and communicating with a cloud-computing environment 140 via a network 130. In some implementations, the user device 110 and/or the cloud-computing environment 140 executes a sequence transduction model 200 that is configured to receive input data/features and generate a sequence of predicted outputs (e.g., a sequence of output tokens). In the example shown, the sequence transduction model 200 includes an automated speech recognition (ASR) model 200 configured to generate one or more predicted transcriptions 202, 202a-n for the spoken utterances 120. Each transcription 202 includes a sequence of output tokens including common tokens 204, 204a-n corresponding to common spoken words of the spoken utterances 120. More specifically, the sequence of common tokens 204 include word or sub-word tokens that form the transcription 202 of the utterance 120. The ASR model 200 may include any transducer-based architecture including, but not limited to, a transformer-transducer (T-T), a recurrent neural network transducer (RNN-T), and/or a conformer-transducer (C-T). The ASR model 200 is also constructed and trained to detect special input conditions in the spoken utterances 120 and to include or embed special tokens 206, 206a-n in a predicted sequence of output tokens (i.e., the transcriptions 202), the special tokens 206 representing the detected special input conditions. Example special input conditions include, but are not limited to, a speaker change (i.e., a change in who is speaking), a spoken key phrase (e.g., a spoken hotword, such as “Hey Alexa”, or a spoken warm word, such as “Volume Up”). In an example, for a spoken utterance 120 of a single user 10 of “Hey Assistant, what time is it,” the ASR model 200 generates a predicted transcription 202 “Hey Assistant <hw>, what time is it.” Here, the transcription 202 includes a special token 206 “<hw>” to indicate that the ASR model 200 identified “Hey Alexa” as a spoken hotword, and common tokens 204 representing the other common words of the transcription 202 (e.g., “what”, “time”, “is”, and “it”). In another example, for a multi-speaker spoken utterance 120 including “word1 word2” spoken by a first user 10a, “word3 word4” spoken by a second user 10b, and “word5 word6” spoken by the first user 10a, the ASR model 200 generates a predicted transcription 202 “word1 word2 <st>word3 word4<st>word5 word6.” Here, the transcription 202 includes special tokens 206 “<st>” to indicate that the ASR model identified speaker changes, and common tokens 204 representing the recognized words in the transcription 202 (e.g., “word1”, “word2”, “word3”, “word4”, “word5”, and “word6”) that were spoken in the multi-speaker spoken utterance 120. For clarity of explanation, the system 100 and the sequence transduction model 200 are described with reference to the ASR model 200 for transcribing spoken utterances 120 and detecting spoken special input conditions, such as speaker changes, and special words (e.g., hotwords and warm words). Moreover, for clarity of explanation, disclosed example methods for augmented training of a sequence transduction model using token-level losses are described using the example of the ASR model 200. However, other type(s) of sequence transduction models for predicting other type(s) of output sequences from other type(s) of input sequences, and for detecting other type(s) of special input conditions may be used. For example, a sequence transduction model may include a character recognition model for transcribing a sequence of written characters into a text sequence, where special input conditions include, but are not limited to, special characters, equations, offensive words, and proper nouns. Another example sequence transduction model includes a machine translation model for translating an input sequence of words in a first language into an output sequence of words in a second language different from the first language, wherein special input conditions include, but are not limited to, proper nouns that don't get translated. Moreover, persons of ordinary skill in the art will recognize that disclosed example methods of augmented training of a sequence transduction model using token-level losses may be used to augment the training of other types of sequence transduction models.

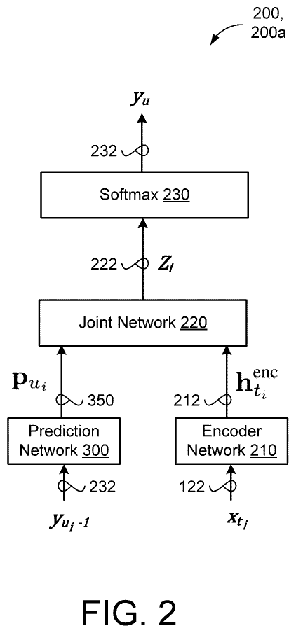

In the example shown, the ASR model 200 includes a recurrent neural network-transducer (RNN-T) model (see FIG. 2) and resides on the user device 110 and/or on the cloud-computing environment 140. The user device 110 and/or the cloud-computing environment 140 also includes an audio subsystem 150 configured to receive utterances 120 spoken by the user(s) 10 and captured by the audio capture device 116a, and convert the captured utterances 120 into a corresponding digital format associated with input audio data 122 (i.e., acoustic frames) capable of being processed by the ASR model 200. Thereafter, the ASR model 200 receives, as input, the audio data 122 corresponding to the utterance 120, and generates/predicts, as output, corresponding predicted transcriptions 202 (e.g., recognition result/hypothesis) of the utterances 120.

The user device 110 may correspond to any computing device associated with a user 10 and capable of capturing audio data. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 110 includes data processing hardware 112 and memory hardware 114 in communication with the data processing hardware 112 and storing instructions that, when executed by the data processing hardware 112, cause the data processing hardware 112 to perform one or more operations. The user device 110 further includes an audio system 116 with an audio capture device (e.g., microphone) 116, 116a for capturing and converting spoken utterances 120 into electrical signals and a speech output device (e.g., a speaker) 116, 116b for communicating an audible audio signal (e.g., as output audio data from the device 110). While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

An output 160 may receive the transcription 202 output from the sequence transduction model 200 that includes a sequence of common tokens 204 associated with words or sub-word units (i.e., graphemes, phonemes, wordpieces) representing words recognized in a spoken utterance 120 and any special tokens 206 the model 200 is trained to detect and embed at a corresponding location in the transcription. The output 160 may include a program (e.g., digital assistant 50) or other component/software that the special token 206 is configured to trigger to perform an operation. For instance, when the special token 206 includes the hotword <hw>, the output may include a natural language understanding/processing (NLU/NLP) module executing on the user device 110 and/or cloud-computing environment 140 that performs query interpretation on the common tokens 204 in the transcription 202 to identify a user command/query and then instructs a downstream component/application to perform an action/operation specified by the command.

The output 160 may also include a user interface generator executing on the user device 110 and/or the cloud-computing environment 140 that is configured to present a representation of the transcriptions 202 to the user 10 of the user device 110. In some examples, the special tokens 206 may indicate speaker change token indicating a respective location in the transcription 202 where a respective speaker change event is detected by the sequence transduction model 200. In these examples, the output 160 corresponding to the user interface generator may annotate the transcription 202 with speaker labels based on the speaker change tokens. The user interface generator may display the initial speech recognition results 202a in a streaming fashion and subsequently display a final speech recognition result 202b.

In the example shown, the user 104 may interact with a program or application 50 (e.g., a digital assistant application 50) of the user device 110 that uses the ASR model 200. For example, the digital assistant application 50 may display a digital assistant interface on a screen of the user device 110 to depict an interaction between the user 10 and the digital assistant application 50. For instance, the digital assistant application 50 may respond to a question posed by the user 10 using NLP/NLU to determine whether the written language prompts any action.

The cloud-computing environment 140 may be a distributed or virtualized system having scalable/elastic resources 142. The resources 142 include computing resources 144 (e.g., data processing hardware) and/or storage resources 146 (e.g., memory hardware) in communication with the computing resources 144 and storing instructions that, when executed by the computing resources 144, cause the computing resources 144 to perform one or more operations. Alternatively, a central or remote server having data processing hardware and memory hardware may be used to implement the operations of the cloud-computing environment 140.

FIG. 2 is a schematic view of an example recurrent neural network-transducer model 200 (i.e., RNN-T model 200) that is trained using long-form training utterances to improve, during inference, speech recognition for long-form utterances. The RNN-T model 200 provides a small computational footprint and utilizes less memory requirements than conventional ASR architectures, making the RNN-T model 200 suitable for performing speech recognition entirely on the user device 110 (e.g., no communication with a remote server is required).

As shown, the RNN-T model 200 includes an encoder network 210, a prediction network 300, a joint network 220, and a final softmax layer 230. The prediction and joint networks 300, 220 may collectively provide an RNN-T decoder. The encoder network 210, which is roughly analogous to an acoustic model (AM) in a traditional ASR system, includes a recurrent network of stacked Long Short-Term Memory (LSTM) layers. For instance, the encoder reads a sequence of d-dimensional feature vectors (e.g., acoustic frames 122 (FIG. 1) x=(x₁, x₂, . . . , x_{T}), where xₜ∈ [symbol] _{d}, and produces at each time step a higher-order feature representation 212. This higher-order feature representation 212 is denoted as

$${h}_{1}^{enc} , … , {h}_{T}^{enc} .$$

Similarly, the prediction network 300 is also an LSTM network, which, like a language model (LM), processes the sequence of non-blank symbols 232 output by the final softmax layer 230 so far, y₀, . . . , yᵤᵢ₋₁, into a dense or hidden representation pᵤ_{ᵢ} 350. Described in greater detail below, the representation pᵤ_{ᵢ} 350 includes a single embedding vector. Notably, the sequence of non-blank symbols 232 received at the prediction network 300 capture linguistic dependencies between non-blank symbols 232 predicted during the previous time steps so far to assist the joint network 220 in predicting the probability of a next output symbol or blank symbol during the current time step. As described in greater detail below, to contribute to techniques for reducing the size of the prediction network 300 without sacrificing accuracy/performance of the RNN-T model 200, the prediction network 300 may receive a limited-history sequence of non-blank symbols 232 yᵤᵢ₋ₙ, . . . , yᵤᵢ₋₁ that is limited to the N previous non-blank symbols 232 output by the final softmax layer 230.

The joint network 300 combines the higher-order feature representation

$${h}_{{t}_{i}}^{enc}$$

212 produced by the encoder network 210 and the representation pᵤ_{ᵢ} 350 (i.e., single embedding vector 350) produced by the prediction network 300. The joint network 220 predicts a distribution Zᵢ=P(yᵢ|xₜ_{ᵢ},y₀, . . . , yᵤ_{ᵢ₋₁}) 222 over the next output symbol. Stated differently, the joint network 220 generates, at each time step, a probability distribution 222 over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 220 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 220 can include a posterior probability value for each of the different output labels. Thus, if there are 100 different output labels representing different graphemes or other symbols, the output Zᵢ 232 of the joint network 220 can include 100 different probability values, one for each output label. The probability distribution can then be used to select and assign scores to candidate orthographic elements (e.g., graphemes, wordpieces, and/or words) in a beam search process (e.g., by the softmax layer 230) for determining the transcription 202.

The final softmax layer 230 receives the probability distribution Zᵢ 232 for the final speech recognition result 220b and selects the output label/symbol with the highest probability to produce the transcription. The final softmax layer 230 may employ any technique to select the output label/symbol with the highest probability in the distribution Zᵢ 232. In this manner, the RNN-T model 200 does not make a conditional independence assumption, rather the prediction of each symbol yᵤ 232 is conditioned not only on the acoustics but also on the sequence of labels 232 yᵤᵢ₋ₙ, . . . , yᵤᵢ₋₁ output so far. The RNN-T model 200 does assume an output symbol 232 is independent of future acoustic frames 122, which allows the RNN-T model to be employed in a streaming fashion.

In some examples, the encoder network 210 of the RNN-T model 200 includes eight 2,048-dimensional LSTM layers, each followed by a 740-dimensional projection layer. In other implementations, the encoder network 210 includes a plurality of multi-headed attention layers. For instance, the plurality of multi-headed attention layers may include a network of conformer or transformer layers. The prediction network 220 may have two 2,048-dimensional LSTM layers, each of which is also followed by 740-dimensional projection layer as well as an embedding layer of 128 units. Finally, the joint network 220 may also have 740 hidden units. The softmax layer 230 may be composed of a unified word piece or grapheme set that is generated using all unique word pieces or graphemes in training data. When the output symbols/labels include wordpieces, the set of output symbols/labels may include 4,096 different word pieces. When the output symbols/labels include graphemes, the set of output symbols/labels may include less than 100 different graphemes.

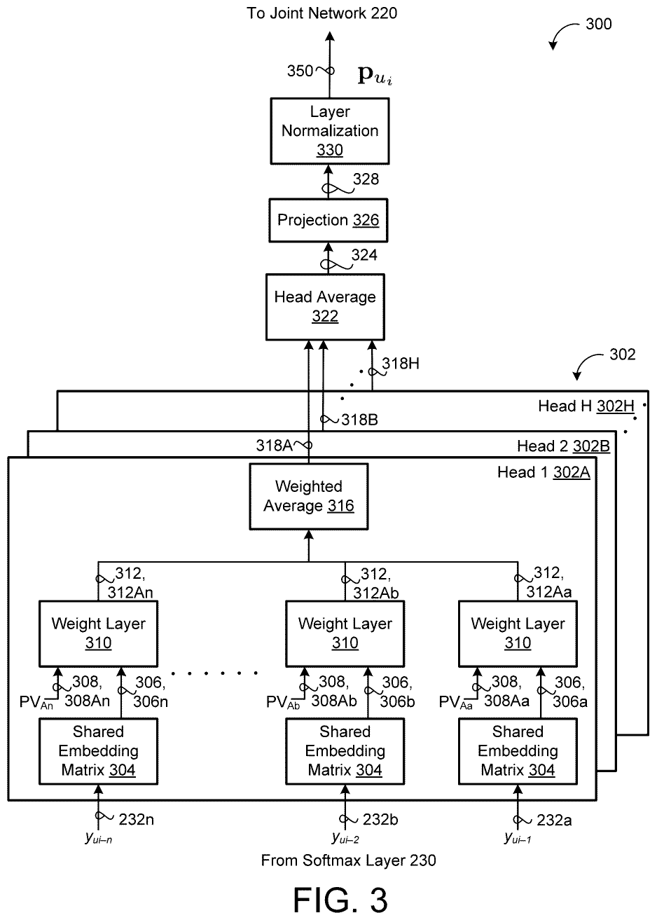

FIG. 3 is a schematic view of an example prediction network 300 for the RNN-T model 200. The prediction network 300 receives, as input, a sequence of non-blank symbols 232a-n yᵤᵢ₋ₙ, . . . , yᵤᵢ₋₁ that is limited to the N previous non-blank symbols 232a-n output by the final softmax layer 230. In some examples, N is equal to two. In other examples, N is equal to five, however, the disclosure is non-limiting and N may equal any integer. The sequence of non-blank symbols 232a-n indicates an initial speech recognition result 202 (FIG. 1). In some implementations, the prediction network 300 includes a multi-headed attention mechanism 302 that shares a shared embedding matrix 304 across each head 302A-302H of the multi-headed attention mechanism. In one example, the multi-headed attention mechanism 302 includes four heads. However, any number of heads may be employed by the multi-headed attention mechanism 302. Notably, the multi-headed attention mechanism improves performance significantly with minimal increase to model size. As described in greater detail below, each head 302A-H includes its own row of position vectors 308, and rather than incurring an increase in model size by concatenating outputs 318A-H from all the heads, the outputs 318A-H are instead averaged by a head average module 322.

Referring to the first head 302A of the multi-headed attention mechanism 302, the head 302A generates, using the shared embedding matrix 304, a corresponding embedding 306, 306a-n (e.g., X∈ [symbol] ^{N×d}^{ₑ}) for each non-blank symbol among the sequence of non-blank symbols 232a-n yᵤᵢ₋ₙ, . . . , yᵤᵢ₋₁ received as input at the corresponding time step from the plurality of time steps. Notably, since the shared embedding matrix 304 is shared across all heads of the multi-headed attention mechanism 302, the other heads 302B-H all generate the same corresponding embeddings 306 for each non-blank symbol. The head 302A also assigns a respective position vector PV_{Aa-An} 308, 308Aa-An (e.g., P∈ [symbol] ^{H×N×d}^{ₑ}) to each corresponding non-blank symbol in the sequence of non-blank symbols 232a-n yᵤᵢ₋ₙ, . . . , yᵤᵢ₋₁. The respective position vector PV 308 assigned to each non-blank symbol indicates a position in the history of the sequence of non-blank symbols (e.g., the N previous non-blank symbols 232a-n output by the final softmax layer 230). For instance, the first position vector PV_{Aa} is assigned to a most recent position in the history, while the last position vector PV_{An} is assigned to a last position in the history of the N previous non-blank symbols output by the final softmax layer 230. Notably, each of the embeddings 306 may include a same dimensionality (i.e., dimension size) as each of the position vectors PV 308.

While the corresponding embedding generated by shared embedding matrix 304 for each for each non-blank symbol among the sequence of non-blank symbols 232a-n yᵤᵢ₋ₙ, . . . , yᵤᵢ₋₁, is the same at all of the heads 302A-H of the multi-headed attention mechanism 302, each head 302A-H defines a different set/row of position vectors 308. For instance, the first head 302A defines the row of position vectors PV_{Aa-An} 308Aa-An, the second head 302B defines a different row of position vectors PV_{Ba-Bn} 308Ba-Bn, . . . , and the H^{th} head 302 H defines another different row of position vectors PV_{Ha-Hn} 308Ha-Hn.

For each non-blank symbol in the sequence of non-blank symbols 232a-n received, the first head 302A also weights, via a weight layer 310, the corresponding embedding 306 proportional to a similarity between the corresponding embedding and the respective position vector PV 308 assigned thereto. In some examples, the similarity may include a cosine similarity (e.g., cosine distance). In the example shown, the weight layer 310 outputs a sequence of weighted embeddings 312, 312Aa-An each associated the corresponding embedding 306 weighted proportional to the respective position vector PV 308 assigned thereto. Stated differently, the weighted embeddings 312 output by the weight layer 310 for each embedding 306 may correspond to a dot product between the embedding 306 and the respective position vector PV 308. The weighted embeddings 312 may be interpreted as attending over the embeddings in proportion to how similar they are to the positioned associated with their respective position vectors PV 308. To increase computational speed, the prediction network 300 includes non-recurrent layers, and therefore, the sequence of weighted embeddings 312Aa-An are not concatenated, but instead, averaged by a weighted average module 316 to generate, as output from the first head 302A, a weighted average 318A of the weighted embeddings 312Aa-An represented by:

$$Prediction ( X , P ) = \frac{1}{H * N} {\sum }_{h , n} {X}_{n} * {\sum }_{e} ( {X}_{n , e} * {P}_{h , n , e} ) \qquad ( 1 )$$

In EQN (1), h represents the index of the heads 302, n represents position in context, and e represents the embedding dimension. Additionally, in EQN (1), H, N, and dₑ include the sizes of the corresponding dimensions. The position vector PV 308 does not have to be trainable and may include random values. Notably, even though the weighted embeddings 312 are averaged, the position vectors PV 308 can potentially save position history information, alleviating the need to provide recurrent connections at each layer of the prediction network 300.

The operations described above with respect to the first head 302A are similarly performed by each other head 302B-H of the multi-headed attention mechanism 302. Due to the different set of positioned vectors PV 308 defined by each head 302, the weight layer 310 outputs a sequence of weighted embeddings 312Ba-Bn, 312Ha-Hn at each other head 302B-H that is different than the sequence of weighted embeddings 312Aa-Aa at the first head 302A. Thereafter, the weighted average module 316 generates, as output from each other corresponding head 302B-H, a respective weighted average 318B-H of the corresponding weighted embeddings 312 of the sequence of non-blank symbols.

In the example shown, the prediction network 300 includes a head average module 322 that averages the weighted averages 318A-H output from the corresponding heads 302A-H. A projection layer 326 with SWISH may receive, as input, an output 324 from the head average module 322 that corresponds to the average of the weighted averages 318A-H, and generate, as output, a projected output 328. A final layer normalization 330 may normalize the projected output 328 to provide the single embedding vector pᵤ_{ᵢ} 350 at the corresponding time step from the plurality of time steps. The prediction network 300 generates only a single embedding vector pᵤ_{ᵢ} 350 at each of the plurality of time steps subsequent to an initial time step.

In some configurations, the prediction network 300 does not implement the multi-headed attention mechanism 302 and only performs the operations described above with respect to the first head 302A. In these configurations, the weighted average 318A of the weighted embeddings 312Aa-An is simply passed through the projection layer 326 and layer normalization 330 to provide the single embedding vector pᵤ_{ᵢ} 350.

In some implementations, to further reduce the size of the RNN-T decoder, i.e., the prediction network 300 and the joint network 220, parameter tying between the prediction network 300 and the joint network 220 is applied. Specifically, for a vocabulary size |V| and an embedding dimension dₑ, the shared embedding matrix 304 at the prediction network is E∈ [symbol] ^{|V|×d}^{ₑ}. Meanwhile, a last hidden layer includes a dimension size dₕ at the joint network 220, feed-forward projection weights from the hidden layer to the output logits will be W∈ [symbol] ^{d}^{ₕ}^{×|V+1|}, with an extra blank token in the vocabulary. Accordingly, the feed-forward layer corresponding to the last layer of the joint network 220 includes a weight matrix [dₕ, |V]|. By having the prediction network 300 to tie the size of the embedding dimension dₑ to the dimensionality dₕ of the last hidden layer of the joint network 220, the feed-forward projection weights of the joint network 220 and the shared embedding matrix 304 of the prediction network 300 can share their weights for all non-blank symbols via a simple transpose transformation. Since the two matrices share all their values, the RNN-T decoder only needs to store the values once on memory, instead of storing two individual matrices. By setting the size of the embedding dimension dₑ equal to the size of the hidden layer dimension dₕ, the RNN-T decoder reduces a number of parameters equal to the product of the embedding dimension dₑ and the vocabulary size |V|. This weight tying corresponds to a regularization technique.

Referring back to FIG. 1, the system 100 includes a two-stage training process 400 that resides on the user device 110 and/or on the cloud-computing environment 140. In some examples, the sequence transduction model 200 resides on the user device 110, and the training process 400 resides on the cloud-computing environment 140. However, the sequence transduction model 200 and the training process 400 can both reside on the user device 110 and/or the cloud-computing environment 140.

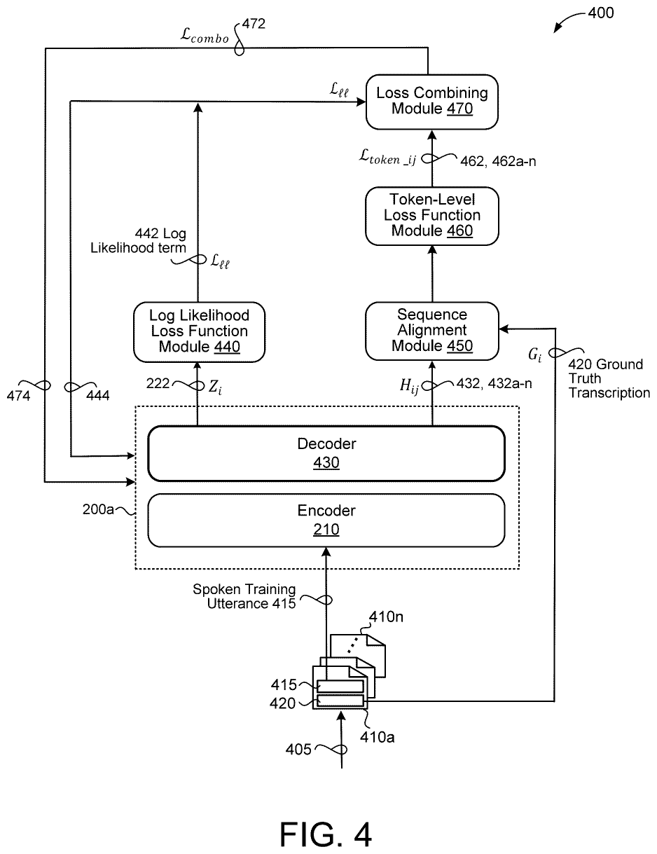

The two-stage training process 400 (see FIG. 4) trains the sequence transduction model 200 (e.g., the ASR model 200) on training data 405 that includes a plurality of training samples 410, 410a-n. Each training sample 410 includes a spoken training utterance 415 (i.e., a sequence of input audio features) and corresponding ground-truth outputs 420 (e.g., a sequence of ground-truth output tokens representing a transcription 420 of the utterance 415). Here, the ground-truth outputs 420 include, in addition to common tokens for spoken words, special tokens for corresponding special input conditions in the input data. That is, the ground-truth outputs 420 are transcriptions that have been augmented with special tokens. An example training sample 410 includes a spoken utterance 415 of “Hey Assistant, what is today's weather” and a corresponding ground-truth transcription 420 of “Hey Assistant <hw>, what is today's weather.” Here, the ground-truth transcription 420 includes the special token “<hw>” immediately after “Hey Assistant” to indicate that the speech recognition model 200 identified “Hey Assistant” as a spoken hotword, and common tokens representing the other spoken words of the utterance (e.g., “what”, “is”, “today's”, and “weather”). Notably, in the example, the common tokens may include word or sub-word unit tokens that form a transcription of the utterance 415.

The training process 400 trains the sequence transduction model 200 (e.g., the ASR model 200) on a sequence transduction task (e.g., a speech recognition performance task). A first stage of the training process 400 initially trains the sequence transduction model 200 to reduce a conventional loss function (e.g., maximizing a negative log likelihood) that is based on differences between the ground-truth output tokens 420 and output tokens 204, 206 generated by the sequence transduction model 200 based on the input spoken training utterance 415. Here, the negative log likelihood function is determined based on all output tokens (i.e., both common and special tokens) of the ground-truth output tokens 420 and output tokens 204, 206 predicted/generated by the sequence transduction model 200 based on the input spoken training utterance 415. Notably, the sparsity of special input conditions in the training data 405 causes the training process 400 to de-emphasize special tokens during the first stage of the training process, which may degrade detection accuracy for special input conditions.

To prevent de-emphasis of learning the special tokens due to their relative sparsity compared to the common tokens, a second stage of the training process 400 then re-trains or fine tunes the sequence transduction model 200 in a second training pass using the same training data 405. For each training sample 410 during the second training pass, the training process 400 performs a beam search to identify the N-best predicted output sequences (i.e., N-best output token sequence hypotheses) based on the input spoken training utterance 415. The second stage of the training process 400 performs the re-training using loss function that is a weighted sum of a token-level loss function and a conventional loss function. The conventional loss function may be the same as that used during the initial training in the first training pass (e.g., maximizing a negative log likelihood). In some implementations, the token-level loss function includes a minimum additive error rate, such as MWER or word-level EMBR, and differences associated with special tokens are given/assigned greater loss values than differences associated with common tokens. Thus, during the second training pass, the training process 400 prioritizes differences associated with special tokens over differences associated with common tokens. In this way, the training process 400 prioritizes learning associated with predicting special tokens, which, thus, compensates for the sparsity of special input conditions in the training data 405.

FIG. 4 is a schematic view of an example two-pass training process 400, 400 for augmenting the training a sequence transduction model 200 using token-level losses. The sequence transduction model 200 may include the RNN-T model 200 of FIG. 2 that includes the encoder 210 and a decoder 430, wherein the decoder 430 collectively includes the prediction network 300 and the joint network 220. The training process 400 may execute on the cloud-computing environment 140 (i.e., on the computing resources 144) and/or on the user device 110 (i.e., on the data processing hardware 112).

For each training sample 410 in the set 405 of trainings samples 410, the first stage of the training process 400 processes, using the RNN-T model 200, the corresponding spoken training utterance 415 to determine the probability Zᵢ 222 that the most likely speech recognition hypothesis for the training utterance 415 is correct (i.e., the likelihood Zᵢ 222 that y 232 equals the corresponding ground truth 420). Thereafter, a log likelihood loss function module 440 determines a negative log likelihood loss term [symbol] 442 based on the probability Zᵢ 222. The log likelihood loss term [symbol] 442 may be expressed as

[symbol]

ₗₗ=−log PR(y*|x), (2)
where Pr(y*|x)=Zᵢ. The first stage of the two-stage training process 400 applies updates 444 to the speech recognition model 200 based on the negative log likelihood loss term [symbol] 442 for each training sample 410 to initialize the speech recognition model 200 in the first training pass.

For each training sample 410 in the set of trainings samples 410, during a re-training of the RNN-T model 200 in a second training pass, the second stage of the training process 400 processes, using the RNN-T model 200, the corresponding spoken training utterance 415 to determine the probability Zᵢ 222 that the most likely speech recognition hypothesis for the training utterance 415 is correct (described above), and to obtain one or more speech recognition hypotheses 432, 432a-n (i.e., output token sequence hypotheses 432) for the training utterance 415. Thereafter, for each training sample 410 and each speech recognition hypothesis 432 output by the RNN-T model 200 for the corresponding training utterance 415, a sequence alignment module 450 determines a respective token-level cost for aligning the speech recognition hypotheses 432 and the corresponding ground-truth transcriptions 420 for the training utterance 415. In some implementations, a token-level cost for aligning the sequences is determined using a customized Levenshtein distance. Here, letting
Hᵢⱼ be the j^{th} speech recognition hypothesis 432 of the N-best speech recognition hypotheses 432 for the i^{th} training sample 410, where i∈[1, M], j∈[1, N], and M is the number of training samples 410;
Pᵢⱼ be the probability Zᵢ 222 for Hᵢⱼ; and
Gᵢ be the ground-truth transcription 420 for the i^{th} training sample 410 (i.e., a sequence of ground-truth output tokens),
   an example customized Levenshtein distance between the sequences Hᵢⱼ and Gᵢ can be determined using the following cost expressions:

$$( 3 )$$

$$subst\_cost ( A , B ) = \{ \begin{matrix}0 & if A == B \\ 1 & if A != < st > , and B != < st > , and A != B \\ + infinite & if A == < st > , or B == < st > , and A != B\end{matrix}$$

$$\begin{matrix}insert\_cost ( A ) = \{ \begin{matrix}1 & if A != < st > \\ K & if A == < st > , K > 1\end{matrix} & ( 4 )\end{matrix}$$

$$\begin{matrix}delete\_cost ( A ) = \{ \begin{matrix}1 & if A != < st > \\ K & if A == < st > , K > 1\end{matrix} & ( 5 )\end{matrix}$$

wherein A represents tokens of Hᵢⱼ, B represents tokens of Gᵢ, and <st> represents a special token. Notably, EQN (2) does not permit substitutions between special tokens and common tokens. Notably, K is greater than one (e.g., slightly greater than one, such as 1.1) such that special token insertions and deletions have more influence compared to common word errors during re-training. Here, the customized Levenshtein distance only permits substitutions between common tokens, and special tokens can only be correct, be deleted or be inserted. The sequence alignment module 450 uses the costs of EQN (3)-(5) to determine an optimal alignment of Hᵢⱼ and Gᵢ for each training sample i 410 that minimizing the customized Levenshtein distances.

The second stage of the training process 400 continues with a token-level loss function module 460 that determines, for each speech recognition hypothesis Hᵢⱼ 432, a token-level cost based on a minimum additive error rate, such as an MWER or a word-level EMBR. That is, the second stage of the training process 400 determines, for each speech recognition hypothesis Hᵢⱼ 432, the number of special token insertions FAᵢⱼ, the number of special token deletions FRᵢⱼ, and the number of common token changes Wᵢⱼ needed to match each aligned speech recognition hypothesis Hᵢⱼ 432 with the ground-truth transcription Gᵢ 420. For each speech recognition hypothesis Hᵢⱼ 432, the token-level loss function module 460 then determines a corresponding token-level loss [symbol] _{token_ij} 462, 462a-n. The token-level loss [symbol] _{token_ij} 462 represents an additive error rate, such as an MWER or a word-level EMBR. In some examples, such as for speaker change detection, for example, the token-level loss [symbol] _{token_ij} 462 is:

[symbol]

_{token_ij}=Pᵢⱼ(α·Wᵢⱼ+β·FAᵢⱼ+γ·FRᵢⱼ)/Qᵢ (6)
where the values of the parameters α, β, and γ control the relative contribution of each subcomponent, and Qᵢ is the total number of output tokens in the ground-truth sequence Gᵢ 420. In some implementations, the values of the parameters β and γ are set to be much larger than the value of the parameter a to force a reduction in special token insertion and deletion rates. In alternative examples, such as for hotword or warm word detections, for example, the token-level loss [symbol] _{token_ij} 462 is:

$${ℒ}_{token\_ij} = {P}_{ij} ( \frac{α \cdot {W}_{i j}}{{Q}_{i}} + \frac{β \cdot {FA}_{i j}}{{G}_{i}} + \frac{γ \cdot {FR}_{i j}}{{G}_{i}} ) \qquad ( 7 )$$

$$where$$

$$F {A}_{i j} = max ( 0 , {H}_{i j} - {G}_{i} ) , \qquad ( 8 )$$

$$and$$

$$F {R}_{i j} = max ( 0 , {G}_{i} - {H}_{i j} ) . \qquad ( 9 )$$

In some implementations, the token-level loss [symbol] _{token_ij} 462 of EQN (6) is used first for speaker change detection, and then the token-level loss [symbol] _{token_ij} 462 of EQN (7) is used for special keyword detection (e.g., hotword or warm word detection). In other implementations, the token-level loss [symbol] _{token_ij} 462 is determined using a combination of EQN (6) and EQN (7).

Thereafter, a loss combining module 470 of the second stage of the training process 400 determines, for the set of training data 405, an overall token-level loss [symbol] ₜₒₖₑₙ, which can be expressed as

[symbol]

ₜₒₖₑₙ=Σ_{i,j} [symbol] _{token_ij}, (10)
and combined losses [symbol] _{combo} 472, 472a-n, which can be expressed as

[symbol]

_{combo}= [symbol] ₜₒₖₑₙ+λ· [symbol] ₗₗ, (11)
where the value of the parameter A controls the relative contributions of the token-level loss [symbol] ₜₒₖₑₙ and the negative log likelihood loss term [symbol] 442 determined by the log likelihood loss function module 440 (i.e., see EQN (2)). The second stage of the two-stage training process 400 applies updates 474 to the speech recognition model 200 based on the combined loss [symbol] _{combo} 472 for each training sample 410 to re-train the speech recognition model 200 in the second training pass.

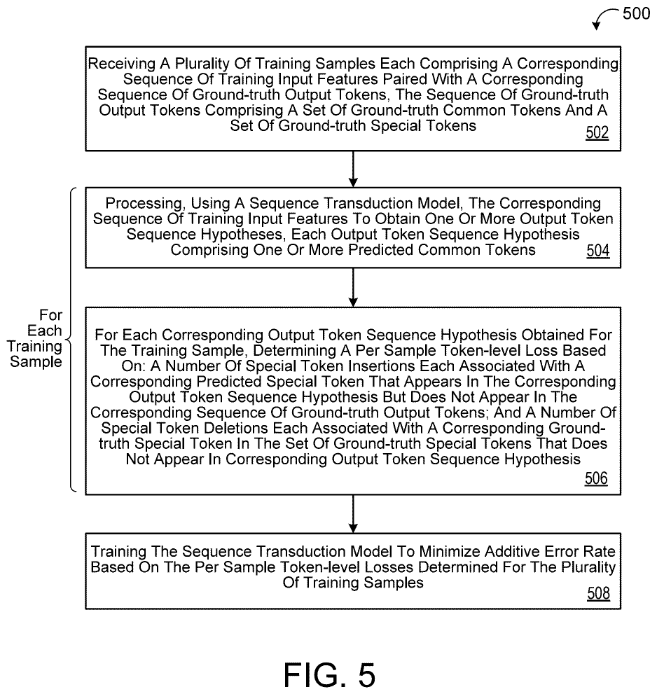

FIG. 5 is a flowchart of an exemplary arrangement of operations for a computer-implemented method 500 for augmenting training of sequence transduction models using token-level losses. At operation 502, the method 500 includes receiving a plurality of training samples 410 each including a corresponding sequence of training input features 415 paired with a corresponding sequence of ground-truth output tokens 420, the sequence of ground-truth output tokens 420 including a set of ground-truth common tokens and a set of ground-truth special tokens.

For each training sample 410 in the plurality of training samples 410, the method 500 includes at operation 504 processing, using a sequence transduction model 200, the corresponding sequence of training input features 415 to obtain one or more output token sequence hypotheses 432, each output token sequence hypothesis 432 including one or more predicted common tokens 204.

For each training sample 410 in the plurality of training samples 410, the method 500 also includes, at operation 506, determining a per sample token-level loss 462 based on, for each corresponding output token sequence hypothesis 432 obtained for the training sample 410: a number of special token insertions FAᵢⱼ each associated with a corresponding predicted special token that appears in the corresponding output token sequence hypothesis 432 but does not appear in the corresponding sequence of ground-truth output tokens 420; and a number of special token deletions FRᵢⱼ each associated with a corresponding ground-truth special token in the set of ground-truth special tokens 420 that does not appear in corresponding output token sequence hypothesis 432.

At operation 508, the method 500 includes training the sequence transduction model 200 to minimize additive error rate based on the per sample token-level losses 462 determined for the plurality of training samples 410.

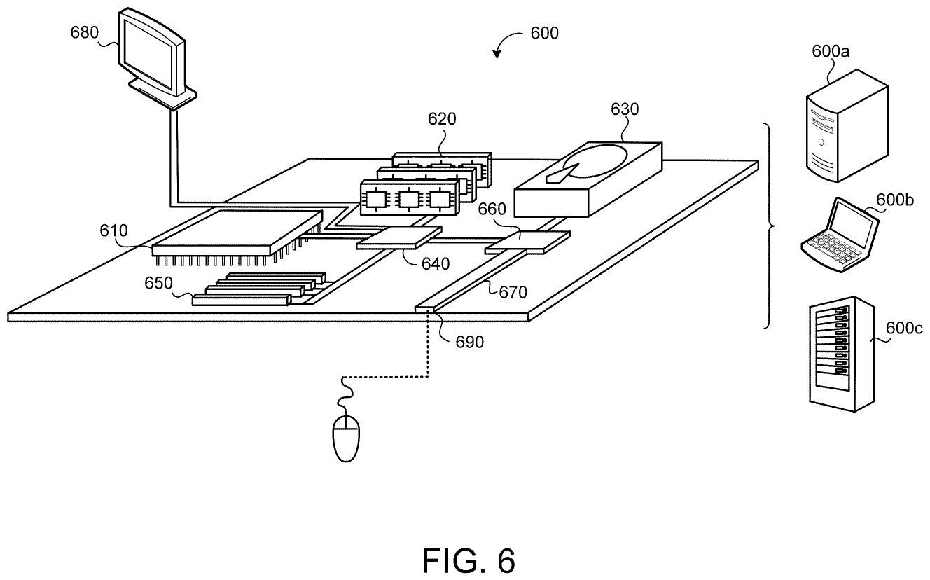

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610 (i.e., data processing hardware) that can be used to implement the data processing hardware 112 and/or 144, memory 620 (i.e., memory hardware) that can be used to implement the memory hardware 114 and/or 146, a storage device 630 (i.e., memory hardware) that can be used to implement the memory hardware 114 and/or 146, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C.

A number of implementations have been described. Nevertheless, it will be understood that various modifications may be made without departing from the spirit and scope of the disclosure. Accordingly, other implementations are within the scope of the following claims.

1. A computer-implemented method when executed on data processing hardware causes the data processing hardware to perform operations comprising:
receiving a plurality of training samples each comprising a corresponding sequence of training input features paired with a corresponding sequence of ground-truth output tokens, the sequence of ground-truth output tokens comprising a set of ground-truth common tokens and a set of ground-truth special tokens;
for each training sample in the plurality of training samples:
processing, using a sequence transduction model, the corresponding sequence of training input features to obtain one or more output token sequence hypotheses, each output token sequence hypothesis comprising one or more predicted common tokens; and
determining a per sample token-level loss based on, for each corresponding output token sequence hypothesis obtained for the training sample:
a number of special token insertions each associated with a corresponding predicted special token that appears in the corresponding output token sequence hypothesis but does not appear in the corresponding sequence of ground-truth output tokens; and
a number of special token deletions each associated with a corresponding ground-truth special token in the set of ground-truth special tokens that does not appear in corresponding output token sequence hypothesis; and
training the sequence transduction model to minimize additive error rate based on the per sample token-level losses determined for the plurality of training samples.

2. The computer-implemented method of claim 1, wherein:
determining the per sample token-level loss is further based on a total number of ground-truth output tokens in the corresponding sequence of ground-truth output tokens and a respective number of predicted common token errors relative to the set of ground-truth common tokens in the corresponding sequence of ground-truth tokens; and
when determining the per sample token-level loss, the number of special token insertions and the number of special token deletions are each weighted higher than the respective number of predicted common token errors to force the sequence transduction model to reduce special token insertion and deletion rates during training.

3. The computer-implemented method of claim 1, wherein the operations further comprise, for each training sample in the plurality of training samples:
processing, using the sequence transduction model, the corresponding sequence of training input features to predict probability distributions over possible output tokens; and
training the sequence transduction model based on a negative log of the probability distributions for the corresponding sequence of ground-truth output tokens conditioned on the corresponding sequence of training input features.

4. The computer-implemented method of claim 3, wherein:
training the sequence transduction model based on the negative log of the probability distributions comprises initially training the sequence transduction model based on the negative log of the probability distributions to initialize the sequence transduction model; and
training the sequence transduction model to minimize additive error rate based on the per sample token-level losses comprises fine tuning the initialized sequence transduction model based on minimizing the additive error rate based on the per sample token-level losses.

5. The computer-implemented method of claim 1, wherein:
processing the corresponding sequence of training input features to obtain one or more output token sequence hypotheses comprises processing the corresponding sequence of training input features to obtain an N-best list of output token sequence hypotheses, each corresponding output token sequence hypothesis in the N-best list having a respective probability score assigned by the sequence transduction model; and
determining the per sample token-level loss is further based on the respective probability score of the corresponding output token sequence hypotheses.

6. The computer-implemented method of claim 1, wherein:
the sequence of training input features comprises a sequence of input audio frames characterizing an utterance that includes a particular key phrase;
the set of ground-truth common tokens in each corresponding sequence of ground-truth output tokens comprises a set of word or sub-word unit tokens that form a ground-truth transcription of the utterance characterized by the sequence of input audio frames;
the set of ground-truth special tokens in each corresponding sequence of ground-truth output tokens comprises at least one ground-truth keyword token indicating a respective location in the ground-truth transcription immediately after the particular key phrase appears in the ground-truth transcription;
the one or more predicted common tokens of each corresponding output token sequence hypothesis of the one or more output token sequence hypotheses comprises a sequence of predicted word or sub-word tokens that form a respective candidate transcription of the utterance; and
each corresponding predicted special token that appears in the corresponding output token sequence hypothesis but does not appear in the corresponding sequence of ground-truth output tokens comprises a predicted key phrase token indicating a respective location in the respective candidate transcription immediately after the sequence transduction model predicts that the particular key phrase is detected.

7. The computer-implemented method of claim 1, wherein:
the sequence of training input features comprises a sequence of input audio frames characterizing multiple utterances spoken by at least two different speakers;
the set of ground-truth common tokens in each corresponding sequence of ground-truth output tokens comprises a set of word or sub-word unit tokens that form a ground-truth transcription of the multiple spoken utterances characterized by the sequence of input audio frames;
the set of ground-truth special tokens in each corresponding sequence of ground-truth output tokens comprises a set of one or more ground-truth speaker change tokens each indicating a respective location where a speaker change occurs in the ground-truth transcription of the multiple utterances;
the one or more predicted common tokens of each corresponding output token sequence hypothesis of the one or more output token sequence hypotheses comprises a sequence of predicted word or sub-word unit tokens that form a respective candidate transcription of the multiple utterances; and
each corresponding predicted special token that appears in the corresponding output token sequence hypothesis but does not appear in the corresponding sequence of ground-truth output tokens comprises a predicted speaker change token indicating a respective location in the respective candidate transcription where a respective speaker change event is detected by the sequence transduction model.

8. The computer-implemented method of claim 1, wherein the operations further comprise, for each training sample in plurality of training samples:
determining a customized Levenshtein distance between each corresponding output token sequence hypothesis of the one or more output token sequence hypotheses obtained for the corresponding sequence of training input features and the corresponding sequence of ground-truth output tokens; and
based on the customized Levenshtein distance:
identifying the number of special token insertions for each corresponding output token sequence hypothesis; and
identifying the number of special token deletions for each corresponding output token sequence hypothesis.

9. The computer-implemented method of claim 8, wherein the customized Levenshtein distance determined between each corresponding output token sequence hypothesis and the corresponding sequence of ground-truth output tokens prevents the sequence transduction model from allowing substitutions between special tokens and common tokens during training of the sequence transduction model.

10. The computer-implemented method of claim 1, wherein the sequence transduction model comprises a recurrent neural network-transducer (RNN-T) model architecture.

11. The computer-implemented method of claim 1, wherein the sequence transduction model comprises at least one of a character recognition model, a speech recognition model, an endpointing model, a speaker turn detection model, or a machine translation model.

12. A system comprising
data processing hardware;
memory hardware in communication with the data processing hardware and storing instructions, that when executed by the data processing hardware, cause the data processing hardware to perform operations comprising:
receiving a plurality of training samples each comprising a corresponding sequence of training input features paired with a corresponding sequence of ground-truth output tokens, the sequence of ground-truth output tokens comprising a set of ground-truth common tokens and a set of ground-truth special tokens;
for each training sample in the plurality of training samples:
processing, using a sequence transduction model, the corresponding sequence of training input features to obtain one or more output token sequence hypotheses, each output token sequence hypothesis comprising one or more predicted common tokens; and
determining a per sample token-level loss based on, for each corresponding output token sequence hypothesis obtained for the training sample:
a number of special token insertions each associated with a corresponding predicted special token that appears in the corresponding output token sequence hypothesis but does not appear in the corresponding sequence of ground-truth output tokens; and
a number of special token deletions each associated with a corresponding ground-truth special token in the set of ground-truth special tokens that does not appear in corresponding output token sequence hypothesis; and
training the sequence transduction model to minimize additive error rate based on the per sample token-level losses determined for the plurality of training samples.

13. The system of claim 12, wherein:
determining the per sample token-level loss is further based on a total number of ground-truth output tokens in the corresponding sequence of ground-truth output tokens and a respective number of predicted common token errors relative to the set of ground-truth common tokens in the corresponding sequence of ground-truth tokens; and
when determining the per sample token-level loss, the number of special token insertions and the number of special token deletions are each weighted higher than the respective number of predicted common token errors to force the sequence transduction model to reduce special token insertion and deletion rates during training.

14. The system of claim 12, wherein the operations further comprise, for each training sample in the plurality of training samples:
processing, using the sequence transduction model, the corresponding sequence of training input features to predict probability distributions over possible output tokens; and
training the sequence transduction model based on a negative log of the probability distributions for the corresponding sequence of ground-truth output tokens conditioned on the corresponding sequence of training input features.

15. The system of claim 14, wherein:
training the sequence transduction model based on the negative log of the probability distributions comprises initially training the sequence transduction model based on the negative log of the probability distributions to initialize the sequence transduction model; and
training the sequence transduction model to minimize additive error rate based on the per sample token-level losses comprises fine tuning the initialized sequence transduction model based on minimizing the additive error rate based on the per sample token-level losses.

16. The system of claim 12, wherein:
processing the corresponding sequence of training input features to obtain one or more output token sequence hypotheses comprises processing the corresponding sequence of training input features to obtain an N-best list of output token sequence hypotheses, each corresponding output token sequence hypothesis in the N-best list having a respective probability score assigned by the sequence transduction model; and
determining the per sample token-level loss is further based on the respective probability score of the corresponding output token sequence hypotheses.

17. The system of claim 12, wherein:
the sequence of training input features comprises a sequence of input audio frames characterizing an utterance that includes a particular key phrase;
the set of ground-truth common tokens in each corresponding sequence of ground-truth output tokens comprises a set of word or sub-word unit tokens that form a ground-truth transcription of the utterance characterized by the sequence of input audio frames;
the set of ground-truth special tokens in each corresponding sequence of ground-truth output tokens comprises at least one ground-truth keyword token indicating a respective location in the ground-truth transcription immediately after the particular key phrase appears in the ground-truth transcription;
the one or more predicted common tokens of each corresponding output token sequence hypothesis of the one or more output token sequence hypotheses comprises a sequence of predicted word or sub-word tokens that form a respective candidate transcription of the utterance; and
each corresponding predicted special token that appears in the corresponding output token sequence hypothesis but does not appear in the corresponding sequence of ground-truth output tokens comprises a predicted key phrase token indicating a respective location in the respective candidate transcription immediately after the sequence transduction model predicts that the particular key phrase is detected.

18. The system of claim 12, wherein:
the sequence of training input features comprises a sequence of input audio frames characterizing multiple utterances spoken by at least two different speakers;
the set of ground-truth common tokens in each corresponding sequence of ground-truth output tokens comprises a set of word or sub-word unit tokens that form a ground-truth transcription of the multiple spoken utterances characterized by the sequence of input audio frames;
the set of ground-truth special tokens in each corresponding sequence of ground-truth output tokens comprises a set of one or more ground-truth speaker change tokens each indicating a respective location where a speaker change occurs in the ground-truth transcription of the multiple utterances;
the one or more predicted common tokens of each corresponding output token sequence hypothesis of the one or more output token sequence hypotheses comprises a sequence of predicted word or sub-word unit tokens that form a respective candidate transcription of the multiple utterances; and
each corresponding predicted special token that appears in the corresponding output token sequence hypothesis but does not appear in the corresponding sequence of ground-truth output tokens comprises a predicted speaker change token indicating a respective location in the respective candidate transcription where a respective speaker change event is detected by the sequence transduction model.

19. The system of claim 12, wherein the operations further comprise, for each training sample in plurality of training samples:
determining a customized Levenshtein distance between each corresponding output token sequence hypothesis of the one or more output token sequence hypotheses obtained for the corresponding sequence of training input features and the corresponding sequence of ground-truth output tokens; and
based on the customized Levenshtein distance:
identifying the number of special token insertions for each corresponding output token sequence hypothesis; and
identifying the number of special token deletions for each corresponding output token sequence hypothesis.

20. The system of claim 19, wherein the customized Levenshtein distance determined between each corresponding output token sequence hypothesis and the corresponding sequence of ground-truth output tokens prevents the sequence transduction model from allowing substitutions between special tokens and common tokens during training of the sequence transduction model.

21. The system of claim 12, wherein the sequence transduction model comprises a recurrent neural network-transducer (RRN-T) model architecture.

22. The system of claim 12, wherein the sequence transduction model comprises at least one of a speech recognition model, a character recognition model, an endpointing model, a speaker turn detection model, or a machine translation model.
